(19) United States
(12) Patent Application Publication
(10) Pub. No.: US 2004/0121083 A1
(43) Pub. Date: Jun. 24, 2004

(54) Method and apparatus for change-over of the molten metal coating composition in a steel strip coating line

(75) Inventors: Jose Carlos Garza-Davila, Nuevo Leon (MX); Oscar Mario Acuna-Gauna, Nuevo Leon (MX); Adrian Eugenio Madero-Garza, Nuevo Leon (MX)

Correspondence Address: FROMMER LAWRENCE & HAUG, 745 FIFTH AVENUE- 10TH FL., NEW YORK, NY, 10151, US

(73) Assignee: GALVAK, S.A. DE C.V., Nuevo Leon (MX)

(21) Appl. No.: 10/699,198

(22) Filed: Oct. 31, 2003

Related U.S. Application Data
(60) Provisional application No. 60/424,529, filed on Nov. 7, 2002.

(51) Int. Cl. B05D 1/18

(52) U.S. Cl. 427/431; 427/433

(57) ABSTRACT

A method and apparatus for rapid and efficient changing-over the coating molten metal in a continuous steel strip coating line from a first aluminum-based coating composition to a second zinc-based coating comprising a first ceramic-lined tank provided with heating means for controlling the temperature of the molten metal in said first tank and a second smaller removable tank without heating means for containing said second coating molten metal adapted to be placed within said first tank, wherein the wall of the second removable tank is effectively heat conductive and preferably has a wall downwardly converging so that its positioning within the first tank is facilitated and damage to its ceramic lining is avoided. The weight of the second tank is mostly supported by the floating forces of the molten bath in said first tank. During use of the second tank, the composition of said first bath is adjusted away from its coating composition by removing a large portion of the aluminum-zinc content and adding zinc to the remaining bath; so that its melting point is lowered to prevent solidification at the zinc coating temperatures, preferably to within 400° C. and 480° C. and its density is preferably in the range of 5.5 to 6.0 tons/m³. The volume of the second tank is designed so as to simplify the adjustment of composition of the first bath by withdrawing a predetermined volume of the aluminum-based coating metal (sufficient to accommodate the placement and immersion of the second tank in the first tank) and adding molten zinc thus obtaining the desired melting temperature and density and filling volume in the first tank.

### RELATED APPLICATION

Benefit is claimed of the prior filing date of provisional application No. 60/424,529, filed Nov. 7, 2002 in accordance with 37 CFR §1.78(4) and 35 USC §119(e).

### FIELD OF THE INVENTION

The present invention relates to the art of continuously coating coiled steel sheet with molten metal alloys, generally known in the industry as galvanizing or aluminizing. More particularly, the invention refers to a method for an efficient change-over of one molten metal coating for another coating of a different composition utilizing a secondary coating tank. By utilizing the invention, the same galvanizing line can produce several different galvanized products by means of a one or more relatively smaller, low-cost auxiliary coating tanks.

### BACKGROUND OF THE INVENTION

Galvanizing lines currently utilized in the steel industry comprise a tank (pot) holding a bath of molten zinc and other metals constituting the coating to be applied to the steel substrate. In continuous coiled steel sheet coating lines, the steel sheet is uncoiled and usually is pretreated comprising several chemical cleaning and heat treating steps under oxidizing and then reducing atmospheres. After pretreatment, the steel sheet is immersed in the tank holding a bath of molten zinc often with aluminum and other metals. The composition of the bath depends on the particular characteristics of the coating which is desired to protect the steel sheet.

The coating tank comprises heating elements, typically electric induction coils for producing heat in the molten metal bath and keeping it liquid at a galvanizing temperatures (typically ranging from about 400° C. to about 600° C. for Zn or Al—Zn coatings), the specific temperature depending on the particular composition of the bath and the temperature and velocity of the steel sheet passing there-through.

The galvanizing tank, known also as the galvanizing pot, is an elaborate piece of equipment subject to severe operating conditions. It is usually made of stainless steel with a thickness of about 2 inches. Its inner surface is lined with ceramic elements to prevent the molten bath from attacking the steel of the pot (especially with a galvanizing coating having high concentrations of aluminum, which is more corrosive). Typically, the galvanizing pot is also lined with a heat insulating material to avoid heat losses to the environment.

The galvanizing tank is always maintained at a high temperature and for practical reasons should not be emptied even while, for whatever reason, it is temporarily not in use; because the thermal shock from even relatively slow cooling produces cracks in the ceramic lining. Typically when a first galvanizing pot is taken out of line while a different coating composition is applied utilizing a second pot, the first pot, though unused, is nevertheless maintained hot with the consequent expense from continued use of electric energy and maintenance during the standby status of the first pot.

The present invention addresses a solution to the problem of change over of the coating composition in a fast and efficient way, without problems of chemical incompatibility of the coatings and also avoiding the capital cost of a second galvanizing pot fully equipped with heater, insulation, etc. for maintaining a separate molten bath of molten metal and also the cost of a second or more holding pots for each of the desired incompatible coating compositions.

U.S. Pat. No. 4,645,694 to Gerard discloses a process for galvanizing metal band with at least two different coating alloys, on one production line, by placing as needed a secondary tank containing the second alloy immersed within the first coating alloy contained within the first tank.

Although Gerard teaches use of a second galvanizing tank with a simpler construction, which is placed within a first conventional tank, Gerard is mute about any preferred procedure of performing the change-over operation or a specific design of the second tank. The features of the present invention improve and allow practical use of the concept described by Gerard in a surprising, unforeseen, and even counterintuitive way.

U.S. Pat. No. 3,130,068 to Whitley teaches that prior art methods then in use required at least 5 days of non-productive time to effect a change-over. To address this problem, Whitley teaches a method for effecting a more rapid change-over from one molten coating metal to another in a single continuous coating line, not by a tank-in-tank method; but rather one that comprises a first step of pumping molten metal from the coating tank into a supplementary holding tank, physically removing the entire first tank from the processing line and replacing it with another tank, and then pumping molten metal from another source into said replaced tank. Whitley thus teaches to have a plurality of holding tanks (in addition to the dipping tanks), each one for each different coating metal. These alternate tanks however are to be maintained hot and must be provided with additional heating elements to keep the coating metal in the liquid state, therefore, the proposed change-over process of Whitley requires a large investment and operating cost.

U.S. Pat. No. 5,912,055 to Gore et al. discloses an apparatus for the continuous hot-dip coating of metal strip. The apparatus includes a first coating pot 11 containing a molten bath of a first coating metal and a second coating pot 21 to hold a molten bath of a second coating metal. The second pot 21 however rests entirely above the bath of the first tank and therefore requires provision of a supporting structure, since no floating forces are exerted on the second pot 21. This apparently is designed to avoid the corrosive effect of the bath on the outer metal of the second smaller pot. However, the heat transfer form the lower bath is essentially lost due to the air gap between the two pots. Thus, another disadvantage of Gore' apparatus is that the second pot requires its own heating means (described as being in the form of electrical resistance heaters mounted on the outer surface of its walls). Gore's concept is not attractive, because it requires more investment costs than the present invention.

Japanese patent publication 59-123753 shows a first galvanizing tank 2 with a coating solution “A” and a second tank 10 containing a second coating metal “B” and placed within said first tank 2. From FIGS. 1 and 2, it may be seen that the second tank 10 rests upon the bottom of the first tank 2 which is not practical because of the danger of damaging the ceramic lining of the first tank. A review of the English abstract reveals little more than is taught by the Gerard patent.

It is therefore an object of the present invention to provide a method and apparatus for practical, rapid and low cost change-over of coating metals in a galvanizing line.

It is another object of the invention to provide a method and apparatus for allowing an existing galvanizing line to produce a variety of products in an efficient way and with low cost.

It is a further object of the invention to provide a method and apparatus for increasing the productivity and pay-back benefits of a galvanizing facility by being able to efficiently change the coating metal.

Other objects will be pointed out hereinafter or will be evident to those skilled in the art.

One of the problems solved by the invention is that the different chemical compositions of various coating metals make them incompatible for being utilized in the same coating tank and with the same accessory devices used for immersing the steel sheet in molten baths. When it is desired to change the product, that is the composition of the coating metal, it would be necessary to clean the tank and usually also all accessory devices in contact with the first bath completely from all traces of the first-used coating metal, which is practically impossible. If such cleaning is not effected, the new coating metal becomes contaminated with the coating metal first used. Sometimes this contamination is strictly unacceptable, for example silicon present in an amount of several parts per million may cause quality problems in some processes.

### SUMMARY OF THE INVENTION

In the most common commercial galvanizing lines, the need to switch between different coating baths is normally between a zinc bath (with typically less than 1% Al) and an aluminum-zinc alloying bath (with a significant, typically major, percentage of Al).

In seeking to make practical application for these two baths of the tank-in-tank galvanizing line of the type shown in Gerard U.S. Pat. No. 4,645,694, applicants discovered a significant problem. This arose because the Al—Zn alloying bath is by far the more corrosive. As a consequence, the tank for the Al—Zn alloying bath requires a heavy ceramic coating as protective liner. The smaller removable tank could not have such a relatively heavy liner, because of the added weight and especially because of the poor thermal conductivity across the wall of a tank having such a heavy ceramic liner. The advantages of the tank-in-tank design are the ability of the smaller inner tank not only to be able to be transferred empty and to be of lighter construction for good handling, but especially to not need a separate heater (instead taking advantage of the heater of the larger fixed tank, by means of heat transferred to the smaller tank during immersion in the molten bath of the larger tank). Consequently, the Al—Zn alloying bath as a practical necessity needs to be contained in the first larger fixed tank (and not in the second smaller removable tank).

However, the problem which arises is that the zinc bath contained in the removable second tank has an operational temperature (e.g. 450° C. to 470° C.) which is below the solidification temperature (e.g. 550° C. to 570° C.) of the Al—Zn alloying bath in the fixed first tank. This can be seen by reference to an Al—Zn binary phase diagram.

This makes the tank-in-tank design as taught by Gerard impractical for the commercial baths with which it would principally be used. For the heater of the larger first tank to be effective in transferring heat to the contents of the inner removable second tank, the temperature would have to be elevated unnecessarily high, so as to render the process inefficient and non-competitive.

Because of the corrosiveness of the Al—Zn alloying bath, this problem could not be overcome merely by reversing the placement of the two different baths in the respective tanks.

Applicants have instead been able to overcome this problem by the unexpected expedient of changing the composition of the aluminum-based bath remaining in the fixed first tank to be more like the composition of the zinc-based bath in the removable second tank during use of the latter. This can be done by adding zinc to dilute the aluminum. This concentration change lowers the melting temperature to reasonable levels. This method is unobvious and even counterintuitive, because the bath in the larger tank normally would be maintained at a constant composition, ready for use when needed. Instead, with this method the bath in the larger tank will have to be changed back to the original composition, when its bath is again needed to be used for coating. This turns out to be relatively simple (being controlled by the proportions used in recharging the first bath back up to full volume after removal of the second tank therefrom).

Thus, the applicants have discovered a method and apparatus for rapid and efficient change-over of the coating molten metal in a continuous steel strip coating line from a first aluminum-based coating composition to a second zinc-based coating comprising a first ceramic-lined tank provided with heating means for controlling the temperature of the molten metal in said first tank and a second smaller removable tank without heating means for containing said second coating molten metal adapted to be placed for partial immersion within said first tank, wherein the wall of the second removable tank is effectively heat conductive and preferably has a wall downwardly converging so that its positioning within the first tank is facilitated and damage to its ceramic lining is avoided. The weight of the second tank and its contents is mostly supported by the floating forces of the molten bath in said first tank. During use of the second tank, the composition of said first bath is adjusted away from its coating composition by removing a large portion of the aluminum-zinc content and adding zinc to the remaining bath; so that its melting point is lowered to prevent solidification at the zinc coating temperatures, preferably to within 400° C. and 480° C. and its density is preferably in the range of 5.5 to 6.0 tons/m³. The volume of the second tank is designed so as to simplify the adjustment of composition of the first bath by withdrawing a predetermined volume of the aluminum-based coating metal (sufficient to accommodate the placement and immersion of the second tank in the first tank) and adding molten zinc thus obtaining the desired melting temperature, improved density and filling volume in the first tank.

The objects of the invention can additionally be more specifically achieved by carrying out a method of changing-over a first molten aluminum-zinc alloying metal coating composition to a second molten zinc coating composition in a metal strip coating line comprising a first tank provided with heating means for controlling the temperature of the molten metal in said first tank during coating of said strip and a second smaller removable tank for containing said second coating molten metal adapted to be partially immersed within said first tank, which method comprises:

withdrawing a first amount of said first coating composition so that the volume emptied from said first tank is sufficient to accommodate the second tank;

modifying the composition of the molten bath in said first tank so that the melting temperature of the molten bath in said first tank is below the operating temperature of the coating molten metal in said second tank, and preferably also the densities are similar;

placing said second tank within said first tank in heat-transfer contact with the first coating molten metal in said first tank;

filling said second tank with the second coating molten metal;

controlling the temperature of the second coating molten metal by controlling the heating means of said first tank.

This method is advantageously applied to a galvanizing process where the first coating composition of a molten metal comprises about 50% to 60% by weight of aluminum, about 40% to 50% by weight of zinc and about 1% to 2% of silicon and the second coating composition of a molten second metal comprises more than about 98% of zinc by weight and less than 1% of aluminum and antimony.

This method further includes returning to the operation of coating said strip with said first coating molten metal by:

withdrawing the molten metal from said second tank;

removing said second tank away from said first tank; and

adjusting the volume and composition of the molten metal bath in said first tank by additions inclusive of silicon and liquid aluminum.

The objects of the invention can additionally be more specifically achieved by providing an apparatus useful in the rapid and efficient change-over of coating molten metal in a strip coating line from an aluminum-based first coating molten metal to a zinc-based second coating molten metal comprising

a first tank provided with an inner ceramic lining and containing a modified molten metal whose constituents are the same as those in said first coating molten metal but in different concentrations sufficient to have a melting temperature and preferably the density also close enough to those of the second coating molten metal to ensure effective heat transfer via the modified molten metal to the second coating molten metal;

heating means for maintaining metal in said first tank in the molten state;

a second smaller removable tank without heating means adapted for containing said second coating molten metal and adapted to be placed within said first tank, said second tank having a downwardly tapering wall to facilitate its positioning within said first tank and avoiding damage to said ceramic lining of the first tank while positioning said second tank within said first tank and while removing said second tank from said first tank;

means for guiding and holding said second tank immersed in the modified molten metal of said first tank;

means adapted for withdrawing a first amount of said first coating composition so that the volume emptied from said first tank is about the volume of the second tank;

means for placing said second tank within said first tank in heat-transfer contact with the modified molten metal in said first tank;

means for filling said second tank with the second coating molten metal;

means for controlling the level of the second coating molten metal in said second tank at about the same level of the molten metal in said first tank; and

means for controlling the temperature of the second coating molten metal at the desired range of operation by regulating the heat provided to said second molten metal by the heating means of said first tank via said modified molten metal

### BRIEF DESCRIPTION OF THE DRAWINGS

In this specification and in the accompanying drawings, we have shown and described preferred embodiments of our invention and have suggested various alternatives and modifications thereof; but it is to be understood that these are not intended to be exhaustive and that many other changes and modifications can be made within the scope of the invention. The suggestions herein are selected and included for purposes of illustration in order that others skilled in the art will more fully understand the invention and the principles thereof and will thus be enabled to modify it in a variety of forms, each as may be best suited to the conditions of a particular use.

FIG. 1 is a schematic diagram as a side cut view of a conventional coating tank.

FIG. 2 is a schematic diagram as a side cut view of the coating tank of FIG. 1 showing the withdrawal of a portion of the coating metal and of the devices used for hot dip immersion of the strip in the coating metal.

FIG. 3 is a schematic diagram as a side cut view of the coating tank of FIG. 2 showing the positioning of a second coating tank to hold a second coating metal.

FIG. 4 is a schematic diagram as a side cut view showing the conventional coating tank and the second removable tank containing an alternate coating metal placed within the first tank and ready for coating the strip with the second coating metal.

### DETAILED DESCRIPTION OF PREFERRED EMBODIMENTS OF THE PRESENT INVENTION

Although the change-over method and apparatus of the invention will be described herein as referred to the change in a galvanizing line of a high aluminum concentration to a high zinc concentration and vice-versa, it will be evident that the invention may also be applied to other continuous or batch processes, for example coating of steel strip, coating of wire or filaments, coating of metal cast products, and in general wherein there are problems similar to those discussed herein such as bath contamination, or the necessity of several heated coating tanks are avoided and their productivity is increased.

A preferred embodiment of the invention will be described with reference to the appended figures wherein numeral 10 generally designates a conventional first coating tank provided with heating elements 12, usually of the electric induction type, which are embedded in a ceramic lining 14 which covers the inner side of a steel wall 16 protecting it from corrosion by the molten bath 18 of Al—Zn alloying coating metal.

A continuous steel strip 24 passes through an enclosing snout 26 which protects the strip 24 from ambient oxygen since the strip 24 is fed to the tank 10 at high temperature (above about 550° C. to 570° C.) after it has been cleaned and pretreated for being coated by immersion in the bath 18 of molten coating metal. A guiding roller 28 is immersed in the molten metal bath 18 around which roller the strip 24 turns; so that it may exit from the molten bath in a substantially vertical direction. Rollers 30 and 32, mounted on a suitable frame not shown for the sake of simplicity, cooperate for the controlled exit of the strip. Air jets from nozzles 34 impinge on the surface of strip 24 for coating control in a manner known in the art.

According to the invention the first tank 10 is provided with a plurality of guides 20, illustrated as pins, which are useful for the precise location and holding of a second tank 22 adapted to be placed within tank 10.

The first step in the illustrative change-over process is to withdraw from the first tank 10 the accessory rolls 28, 30 and 32 and other devices used for the controlled immersion of strip. Then, as indicated in FIG. 2, a first amount of the first coating bath 18 is withdrawn from the first tank 10 by means of a pump 36 and conduits 38 and 40.

Molten zinc is added to the bath of the first tank 10; so that the concentration of aluminum is lowered, preferably from about 55% to about 10%; so as to lower the solidification temperature of the first bath for it to be molten while the galvanizing second bath is in use. In the instant example, about 35 tons of the first coating were withdrawn from the first tank 10 and about 72 tons of zinc were added to the bath 18 to form a new bath 44. The molten alloy withdrawn from the first tank is poured into molds, not shown, for its solidification and storage (as is known in the art). With the described change of composition and conditions in the first tank, the solubility of some iron compounds formed in the bath, known also as dross, decreases and consequently the dross precipitates and floats at the bath surface. This dross is removed therefrom by mechanical means. The density of the new bath 44 in the first tank 10 is now more similar to the density of the second bath 46 in the second tank 22. The dross elimination is not an essential part of the change-over process, but it is advantageously done during the composition change and the time necessary for placing the second tank 22 into its operating position.

After all dross has been skimmed, about 10 cubic meters of molten metal are extracted from the first tank using a centrifugal pump, leaving only about 5 cubic meters in the first tank comprising the following representative composition:

| | Tank 10 (bath 44) |
|---|---|
| Aluminum | 10.0 weight % |
| Zinc | 89.9 |
| Silicon | 0.1 |

It is desirable that the volume of the second tank has about the same volume of the molten metal which is withdrawn from the first tank such that the composition of the bath remaining in the first tank can be adjusted to the operating levels and temperatures by only adding a predetermined amount of molten zinc, within the restrictions imposed by the volumes and lay-out of the existing first tank.

The ceramic lining of the first tank 14 should be always maintained at a temperature above about 350° C. to avoid thermal shocks and consequent damage to the lining, therefore, the first tank is never fully emptied of molten metal.

The second tank 22 is preheated in a furnace (not shown) to a temperature of about 400° C. and is preferably coated in its outer surface with a thin ceramic zirconium-based paint-like coating used to protect the rollers 28, 30 and 32 as well as the supporting frame from the corrosive attack of the modified molten bath 44.

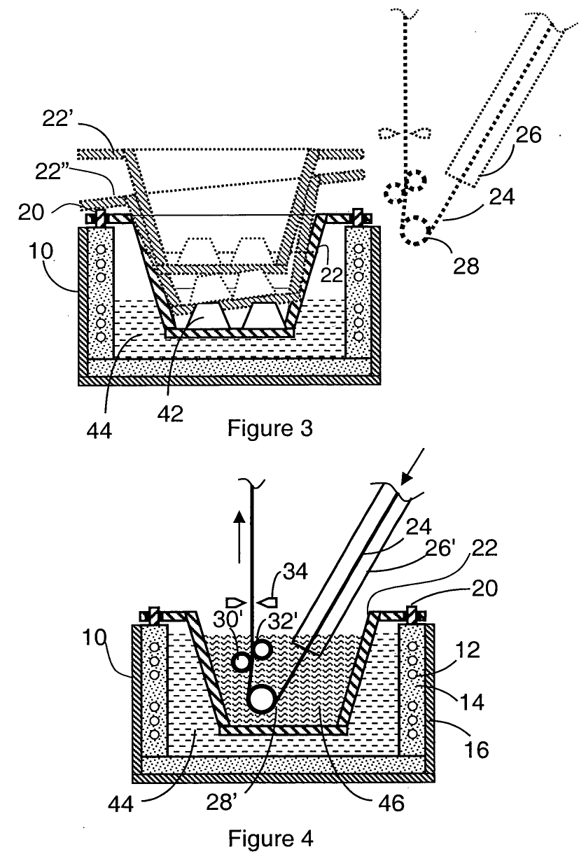

As illustrated in FIG. 3, the second tank 22 containing about 2 tons of solid zinc 42 is then placed within said first tank 10 by means of a suitable crane or other means. Successive positions of the second tank during placement are illustrated in dotted lines as 22′, 22″, with the final installed position shown in full lines as 22. Solid zinc 42 is placed in the second tank for added weight and stability while the second tank is lowered within the first tank (which tends to float in the molten bath 44 causing buoyant movements, which might damage lining 14 of the first tank 10). The downwardly converging wall of the second tank 22 allows for some movement without tipping against the lining 14. The solid zinc adds weight to the second tank without the difficulties of handling liquid metal while moving said second tank until its final position, which solid zinc will be melted when the remaining capacity of the second tank is filled with molten zinc. Guides 20 are useful for fixing the second tank 22 in its operating position within the first tank 10. After the second tank 22 is fixed in its operating position within the tank 10, it is filled in this illustrative example with about 50 tons of molten zinc and the desired coating composition is adjusted by adding the necessary bars of zinc with aluminum and zinc with antimony. In this case, about 1.4 tons of zinc bars with 10% aluminum and about 1 ton of zinc bars with 6% of antimony were added to the bath 46 of the second tank 22.

During the time the molten metal bath levels are low during the positioning of the second tank 22 into or out of the first tank 10, the ceramic lining 14 is desirably heated by suitable burners in order to prevent the consequently exposed ceramic lining from undergoing thermal shocks and developing cracks.

As illustrated in FIG. 4, once the second tank 22 is filled with the second coating metal to form a molten bath 46 with the desired composition, the rollers 28, 30 and 32 and all other devices utilized for the immersion of the strip 24 are placed back in their operational position (or where needed to avoid contamination of the second bath 46, at least the portion placed in the bath 46 is substituted by equivalent structures 28′, 30′ and 32′) and the coating operation is resumed to coat the strip now with the second coating metal from bath 46.

The operation is controlled by regulating the heat provided by heating means 12 of tank 10, which is transmitted by the bath 44 to bath 46 through the wall of tank 22.

For the case of one particular operating plant of the applicants' assignee, the molten baths 44 and 46 had the following compositions in weight %:

| | Tank 22 (bath 46) | Tank 10 (bath 44) |
|---|---|---|
| Aluminum | 0.18 | 8.87 |
| Antimony | 0.09 | — |
| Silicon | — | 0.25 |
| Iron | 0.025 | 0.013 |
| Lead | 0.001 | 0.001 |
| Zinc | 99.7 | 90.9 |
| Density (Tons/m3) | 6.40 | 5.63 |
| Melting point (° C.) | 419 | 414 |

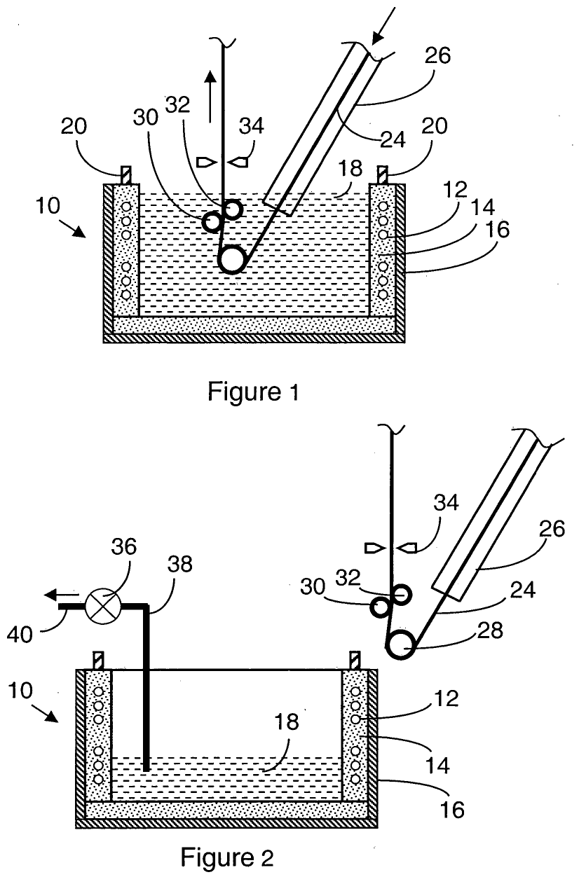

The change-over operation to return to using the first coating metal bath 18 of high aluminum concentration in tank 10 comprises the steps of withdrawing from tank 22 the rollers 28′, 30′ and 32′ as well as all other devices utilized for the normal operation of the strip coating; emptying the second tank 22 by pumping the liquid metal 46 with a centrifugal pump. While the molten metal 46 is being withdrawn, tank 22 tends to float and it can be lifted by a suitable crane after being released from guides and suitable fixing devices 20. After removal of tank 22, the necessary amount of aluminum and silicon is pumped or poured into the first tank 10 to adjust the composition of the bath 44 back to the desired levels (thus forming a bath 18), and the rollers 28, 30 and 32 are returned to the normal operating arrangement as illustrated in FIG. 1.

In the applicants' assignee's plant, the composition of bath 18 in weight % was as follows:

| | Tank 10 (bath 18) |
|---|---|
| Aluminum | 53.11 |
| Silicon | 1.35 |
| Iron | 0.018 |
| Lead | 0.002 |
| Zinc | 45.52 |

The method and apparatus herein described and claimed allows for a rapid and efficient change-over of coating metal with a minimum handling of liquid metals and with a very low investment cost. The method can be applied to accommodate a third or even more different coating compositions having similar problems by merely having each such added composition have its own separate removable inner tank. Otherwise, no additional coating tanks are necessary and the removable tank does not need separate heating means or no duplicative processing line structure. The invention herein described is not limited to the embodiment shown in the specification, which is intended to be only illustrative. Many modifications may be made without departing from the spirit of the invention, the scope of which is only limited by the scope of the appended claims.

What we claim is:

1) A method of changing-over a first molten aluminum-zinc alloying metal coating composition to a second molten zinc coating composition in a metal strip coating line comprising a first tank provided with heating means for controlling the temperature of the molten metal in said first tank during coating of said strip and a second smaller removable tank for containing said second coating molten metal adapted to be partially immersed within said first tank, which method comprises:
withdrawing a first amount of said first coating composition so that the volume emptied from said first tank is sufficient to accommodate the second tank;
modifying the composition of the molten bath in said first tank so that the melting temperature of the molten bath in said first tank is below the operating temperature of the coating molten metal in said second tank;
placing said second tank within said first tank in heat-transfer contact with the first coating molten metal in said first tank; filling said second tank with the second coating molten metal;
controlling the temperature of the second coating molten metal by controlling the heating means of said first tank.

2) A method according to claim 1, further comprising maintaining the upper level of the second coating molten metal in said second tank at about the same upper level of the first coating molten metal in said first tank.

3) A method according to claim 2, wherein the first coating has a composition of a molten metal comprising about 50% to 60% by weight of aluminum, about 40% to 50% by weight of zinc and about 1% to 2% of silicon, and wherein the second coating has a composition of a molten second metal comprising more than about 98% of zinc by weight and less than 1 % of aluminum and antimony.

4) A method according to claim 3, wherein said modifying step is accomplished by adding molten zinc, as at least the major constituent, to the first coating composition remaining in the first tank after the withdrawal of said first amount thereof, such that the concentration of aluminum in the first tank is lowered from about 55% to about 10% in order to effectively lower the solidification temperature of the molten bath in the first tank for it to be molten while the galvanizing second bath is in use.

5) A method according to claim 4, wherein the composition of said modified molten metal in said first tank is modified to have a density in the range of 5.5 to 6.0 tons/m³ and a melting temperature of about 400° C. to about 480° C.

6) A method according to claim 5, further comprising preheating in a furnace said second tank to a temperature above about 400° C.

7) A method according to claim 6, further comprising withdrawing from the surface of the molten bath of said first tank, iron compounds, dross, which tends to float when increasing the density of the first bath by adding zinc.

8) A method according to claim 7, further comprising coating the external side of the wall of said second tank with a zirconium-based coating for protecting it against the chemical action of the molten metal bath in said first tank.

9) A method according to claim 1, further comprising providing heat to any exposed portion of the ceramic lining of said first tank, by means of burners so as to avoid thermal shocks to said ceramic lining.

10) A method according to claim 1, further comprising the following steps for returning to the operation of coating said strip with said first coating molten metal:
withdrawing the molten metal from said second tank;
removing said second tank away from said first tank; and
adjusting the volume and composition of the molten metal bath in said first tank by additions inclusive of silicon and liquid aluminum.

11) Apparatus adapted for rapid and efficient change-over of coating molten metal in a strip coating line from an aluminum-based first coating molten metal to a zinc-based second coating molten metal comprising
a first tank provided with an inner ceramic lining and containing a modified molten metal whose constituents are the same as those in said first coating molten metal but in different concentrations sufficient to have a melting temperature and density close enough to those of the second coating molten metal to ensure effective heat transfer via the modified molten metal to the second coating molten metal;
heating means for maintaining metal in said first tank in the molten state;
a second smaller removable tank without heating means adapted for containing said second coating molten metal and adapted to be placed within said first tank, said second tank having a downwardly tapering wall to facilitate its positioning within said first tank and avoiding damage to said ceramic lining of the first tank while positioning said second tank within said first tank and while removing said second tank from said first tank;
means for guiding and holding said second tank immersed in the modified molten metal of said first tank;
means adapted for withdrawing a first amount of said first coating composition so that the volume emptied from said first tank is about the volume of the second tank;
means for placing said second tank within said first tank in heat-transfer contact with the modified molten metal in said first tank;
means for filling said second tank with the second coating molten metal;
means for controlling the level of the second coating molten metal in said second tank at about the same level of the molten metal in said first tank; and
means for controlling the temperature of the second coating molten metal at the desired range of operation by regulating the heat provided to said second molten metal by the heating means of said first tank via said modified molten metal.

12) Apparatus according to claim 11, wherein the composition of said modified molten metal of said first tank has a density in the range of 5.5 to 6.0 tons/m³ and a melting temperature above about 400° C. to about 480° C.

13) Apparatus according to claim 11, further comprising a furnace for preheating said second tank to a temperature above 400° C. prior to its positioning within said first tank.

14) Apparatus according to claim 11, wherein said second tank comprises a wall made of stainless steel 316 L.

15) Apparatus according to claim 14, wherein the outer wall of said second tank is coated with a zirconium-based coating for its protection against the chemical action of the molten metal bath in said first tank.
